(19) United States
(12) Patent Application Publication
(10) Pub. No.: US 2008/0309494 A1
(43) Pub. Date: Dec. 18, 2008

(54) LINE-OF-SIGHT RFID TAG READER

(76) Inventor: Ajang Bahar, Kitchener (CA)

Correspondence Address: HERMAN & MILLMAN, 141 ADELAIDE ST. WEST, SUITE 1002, TORONTO, ON, M5H 3L5, CA

(21) Appl. No.: 11/761,521

(22) Filed: Jun. 12, 2007

(51) Int. Cl. H04B 7/00

(52) U.S. Cl. 340/572.7; 340/572.1

(57) ABSTRACT

Provided by aspects of the invention are devices, systems and methods for enabling the use of RFID tags that are not unnecessarily complex by changing the arrangement and operation of RFID tag readers Specifically, provided in some embodiments in accordance with aspects of the invention is a RFID tag reader incorporating a type of highly directional antenna, known as a pencil beam antenna. In operation, a pencil beam antenna has a highly focused and thinly shaped lobe. Those skilled in the art will appreciate that an antenna lobe is the volume of space within which RF signals can be detected and coupled to a receiver connected to the pencil beam antenna or within which RF signals can propagate after being transmitted by a transmitter connected to the pencil beam antenna. The highly focused and thinly shaped lobe created by the pencil beam antenna enables selective communication with individual RFID tags, even those RFID tags incorporating low-directivity antennas.

### FIELD OF THE INVENTION

The invention relates to the use of Radio Frequency Identification (RFID) tags, and in particular to a selective communication with RFID tags.

### BACKGROUND OF THE INVENTION

Radio Frequency Identification (RFID) tags provide a useful way of labeling and tracking articles and containers. A RFID tag can be programmed to contain information either during the manufacture of the RFID tag and/or in the field after the RFID tag has been affixed to an article or container. For example, a particular RFID tag can programmed to contain information about the contents of a container used for shipping (e.g. type of articles in the container, quantity of each type of article, etc.). RFID tags can function under a variety of environmental conditions and provide a high level of data integrity, while also being cheap enough to be considered disposable and easily replaceable. Yet more complex RFID tags are typically more expensive. So the cost of RFID tags is a factor considered in developing a system using RFID tags, with unnecessarily complex RFID tags considered undesirable.

In use, information on a RFID tag is read (or written) using modulated electromagnetic energy in the radio frequency bands. This is accomplished by the creation of an ad hoc wireless communication channel between a RFID tag reader and one or more RFID tags in a particular area. Communication is initiated when the RFID tag reader transmits a polling signal into a particular space containing one or more RFID tags affixed to articles or containers The RFID tags are designed to automatically respond to the polling signal, providing information to the RFID reader.

An often relied upon advantage of a conventional RFID tag is that the RFID tag does not require contact or a line-of-sight wireless channel to communicate with a reader. To that end, the antenna provided in a RFID tag typically has very low directivity to ensure that the RFID tag can be read (or written to) without a direct line-of-sight. More specifically, a typical RFID tag includes an antenna that has a quasi-spherical (omni-directional) beam pattern meaning that RF energy transmitted from the RFID tag propagates in a quasi-spherical manner away from the RFID tag. In some cases, an RFID tag includes a back plate to prevent RF energy from propagating into or through an article or container that the RFID tag is attached to, and instead is mostly directed away from the article or container. Low-directivity antennas are often less complex and cheaper to manufacture than more directional antennas, which helps to keep the cost of RFID tags down.

RFID tag readers also typically have low-directivity antennas, which also means that RF energy transmitted from the RFID tag reader propagates in a quasi-spherical manner away from the RFID tag reader. There are a number of advantages to providing a RFID tag reader with a low-directivity antenna. First, the RFID tag reader can be used to indiscriminately poll and receive information from multiple RFID tags at the same time. Second, low-directivity antennas provide for the flexible use and installation of a RFID tag reader by not imposing strict requirements on the orientation and positioning of the RFID tag reader.

The use of non-directional antennas does have disadvantages. First, the information transmitted between the RFID tag and reader may be easily intercepted and read by an unintended party. Second, in a particular space containing numerous RFID tags it is difficult to select a particular RFID tag to read or program (write to). For example, in a warehouse containing multiple boxes, where each box is labeled with a respective RFID tag, some of the RFID tags may indicate that the same type of article is in a corresponding subset of the boxes. However, there may be varying quantities of the article in each of the subset of boxes. Using a conventional RFID tag reader located within the warehouse (or in a hand-held device) it is possible to determine the number of boxes with a particular type of article that are in the warehouse, and even the number of boxes with a particular quantity of the particular article. However, it would be difficult to precisely locate those boxes within the warehouse or read/program a RFID tag on a particular box that is relatively close to other RFID tags. In order to locate particular boxes or read/program a particular RFID tag to the exclusion of others, the RFID tag reader must be positioned close enough to a particular RFID tag to ensure that only that particular RFID tag is being read/programmed. Alternatively, more complex and more expensive RFID tags having batteries and more sophisticated processing functions may be employed.

### SUMMARY OF THE INVENTION

According to an aspect of an embodiment of the invention, there is provided a Radio Frequency Identification (RFID) tag reader including: a highly-directional antenna operable to create a highly focused and thinly shaped lobe, the lobe being the volume of space within which Radio Frequency (RF) signals can be detected and coupled to the RFID tag reader and also within which RF signals can propagate after being transmitted by the RFID tag reader; a transmit signal chain operable to produce a transmission signal at a RF frequency, the transmit signal chain operably connectable to the highly-directional antenna; a receive signal chain operable to accept and down-convert a received signal at a RF frequency, the receive signal chain operably connectable to the highly-directional antenna for accepting the received signal at the RF frequency; and a controller for managing the operation of the RFID tag reader, the controller operably connected to the transmit and the receive signal chains.

In some embodiments, the RFID tag reader also includes a user interface for permitting a user to direct the use of the RFID tag reader, the user interface operably connectable to the controller, wherein the controller accepts input instructions from a user through the user interface and provides feedback to the user through the user interface. In some more specific embodiments, the user interface includes at least one of a key pad, a display and a touch screen.

In some embodiments, the controller is further connectable to another system employing the functionality of the RFID tag reader.

In some embodiments, the RFID tag reader also includes a circulator for selectively connecting at least one of the transmit signal chain and the receive signal chain to the highly directional antenna.

In some embodiments, the RFID tag reader also includes a multiplexer for selectively connecting at least one of the transmit signal chain and the receive signal chain to the highly directional antenna.

In some embodiments, the RFID tag reader also includes a targeting element for aiming the highly focused and thinly shaped lobe created by the highly directional antenna. In some more specific embodiments, the targeting element comprises a coherent light source that emits laser light substantially through the center of the highly focused and thinly shaped lobe created by the highly-directional antenna, wherein the laser light is within the spectrum of visible light and in operation serves as a guide for directing the highly focused and thinly shaped lobe of the antenna.

In some embodiments, the RFID tag reader also includes an optical light emitter connected to the coherent light source, the optical light emitter arranged in front of the highly-directional antenna, whereby in operation, the laser light and the antenna lobe overlap along the length of the antenna lobe.

In some embodiments, the targeting element comprises a viewfinder for aiming the highly focused and thinly shaped lobe.

According to an aspect of an embodiment of the invention, there is provided a method of operating a Radio Frequency Identification (RFID) tag reader having a highly-directional antenna, the highly-directional antenna operable to produce a highly-focused and thinly shaped lobe, the method including: aiming the highly-focused and thinly shaped lobe at a RFID tag; transmitting a signal to the RFID tag; and receiving a signal back from the RFID tag.

In some embodiments, the method also includes visually selecting the RFID tag with which communication is desired. In some other embodiments, the method also includes using a targeting element for aiming the highly-focused and thinly shaped lobe at the RFID tag. In some even more specific embodiments, the targeting element includes one of a laser sight aligned with the highly focused and thinly shaped lobe and a viewfinder.

In some embodiments, the method also includes: receiving a response including an authentication key from the RFID tag; determining whether or not communication is permitted between the RFID tag reader and the RFID tag based on evaluation of the authentication key; indicating to the user the result of the evaluation; and permitting communication depending on the result of the evaluation.

In some embodiments, the method also includes: receiving a response including an authorization message from the RFID tag; determining whether or not communication is permitted between the RFID tag reader and the RFID tag based on evaluation of the authorization message; indicating to the user the result of the evaluation; and permitting communication depending on the result of the evaluation.

In some embodiments, the method also includes: transmitting an authentication key to the RFID tag; receiving a response including an authorization message from the RFID tag; determining whether or not communication is permitted between the RFID tag reader and the RFID tag based on evaluation of the authorization message; indicating to the user the result of the evaluation; and permitting communication depending on the result of the evaluation.

Other aspects and features of the present invention will become apparent to those ordinarily skilled in the art, upon review of the following description of the specific embodiments of the invention in accordance with either of the aspects described above.

### BRIEF DESCRIPTION OF THE DRAWINGS

For a better understanding of the present invention, and to show more clearly how it may be carried into effect, reference will now be made, by way of example, to the accompanying drawings, which illustrate aspects of embodiments of the present invention and in which:

FIG. 1 is a schematic view of a Radio Frequency Identification (RFID) tag reader provided in accordance with aspects of the invention;

FIG. 2 is an illustration depicting a method of use of a RFID tag reader in accordance with aspects of the invention;

FIG. 3 is a first flow chart illustrating general method steps for operating a RFID tag reader in accordance with aspects of the invention; and

FIG. 4 is a second flow chart illustrating method steps for operating a RFID tag reader in accordance with aspects of the invention.

### DETAILED DESCRIPTION OF THE INVENTION

Radio Frequency Identification (RFID) tags provide a useful way of labeling and tracking articles and containers. However, the incorporation of low-directivity antennas in RFID tags and RFID tag readers makes it difficult to select a particular RFID tag to read or program (write to) to the exclusion of others. The use of low-directivity antennas also makes it difficult to prevent communication between a RFID tag and a RFID tag reader from being intercepted and read by an unintended party. Prior efforts to overcome these and related issues result in RFID tags of increased complexity, which in turn often increases the cost of the RFID tags. In the design of a system using RFID tags it would be preferable to use lower-cost RFID tags when it is feasible, since such systems employ significant numbers of RFID tags and many of those RFID tags will likely be replaced due to damage, loss or being discarded.

Provided by aspects of the invention are devices, systems and methods for enabling the use of RFID tags that are not unnecessarily complex by changing the arrangement and operation of RFID tag readers. Specifically, provided in some embodiments in accordance with aspects of the invention is a RFID tag reader incorporating a type of highly-directional antenna, known as a pencil beam antenna. In operation, a pencil beam antenna has a highly focused and thinly shaped lobe. Those skilled in the art will appreciate that an antenna lobe is the volume of space within which RF signals can be detected and coupled to a receiver connected to the pencil beam antenna or within which RF signals can propagate after being transmitted by a transmitter connected to the pencil beam antenna. The highly focused and thinly shaped lobe created by the pencil beam antenna enables selective communication with individual RFID tags, even those RFID tags having low-directivity antennas.

Additionally and/or alternatively, in some embodiments a RFID tag reader provided in accordance with aspects of the invention also includes a targeting element for aiming the highly focused and thinly shaped lobe created by the pencil beam antenna. Specifically, in one embodiment, an RFID tag reader includes a coherent light source (or laser) that emits laser light substantially through the center of the highly focused and thinly shaped lobe created by the pencil beam antenna. The laser light is within the spectrum of visible light and in operation serves as a guide for directing the highly focused and thinly shaped lobe of the antenna, which is, as is understood by those skilled in the art, not visible to the human eye. In order to ensure that the laser light serves as an accurate guide for aiming the antenna lobe, an optical light emitter is arranged in front of the pencil beam antenna so that, in operation, the laser light and the antenna lobe overlap along the length of the antenna lobe. In some embodiments, the optical light emitter includes a optical fiber terminated by a lens end-cap. Those skilled in the art will appreciate that non-metallic components (such as glass or high index plastics) arranged in close proximity to the antenna will have less, if any, impact on the operation of the antenna than metallic components will have.

Additionally and/or alternatively, a RFID tag reader in accordance with aspects of the invention may include a viewfinder serving as the targeting element for aiming the highly focused and thinly shaped lobe at a target RFID tag.

Additionally and/or alternatively, a RFID tag reader in accordance with aspects of the invention may be incorporated into a system in which the RFID tag reader is mounted so that the highly focused and thinly shaped lobe created by the antenna is fixed to cover a known location and a RFID tag can be read only at that location. For example, a RFID tag reader provided in accordance with aspects of the invention may be placed above a portion of a conveyor belt so as to be able to read/program RFID tags passing by one at a time on the conveyor belt below.

Moreover, those skilled in the art will appreciate that there are many applications for the use and integration of an RFID tag reader in accordance with aspects of the invention in view of the following. As such, the following is not provided to restrict the claims included herein, but is merely provided to help illustrate aspects of the inventions by providing a detailed example of those aspects as employed by the inventor in one embodiment.

Aspects of the invention may be embodied in a number of forms. For example, various aspects of the invention can be embodied in a suitable combination of hardware, software and firmware. In particular, some embodiments include, without limitation, entirely hardware, entirely software, entirely firmware or some suitable combination of hardware, software and firmware. In a particular embodiment, the invention is implemented in a combination of hardware and firmware, which includes, but is not limited to firmware, resident software, microcode and the like.

Additionally and/or alternatively, aspects of the invention can be embodied in the form of a computer program product that is accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by, or in connection with, the instruction execution system, apparatus, or device.

A computer-readable medium can be an electronic, magnetic, optical, electromagnetic, infrared, or semiconductor system (or apparatus or device) or a propagation medium. Examples of a computer-readable medium include a semiconductor and/or solid-state memory, magnetic tape, a removable computer diskette, a random access memory (RAM), a read-only memory (ROM), a rigid magnetic disk and an optical disk. Current examples of optical disks include, without limitation, compact disk—read only memory (CD-ROM), compact disk—read/write (CD-R/W) and DVD.

In accordance with aspects of the invention, a data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Additionally and/or alternatively, in accordance with aspects of the invention, a data processing system suitable for storing and/or executing program code will include at least one processor integrated with memory elements through a system bus.

Input/output (i.e. I/O devices) including but not limited to keyboards, touch-pads, displays, pointing devices, etc.—can be coupled to the system either directly or through intervening I/O controllers.

Network adapters may also be coupled to the system to enable communication between multiple data processing systems, remote printers, or storage devices through intervening private or public networks. Modems, cable modems and Ethernet cards are just a few of the currently available types of network adapters.

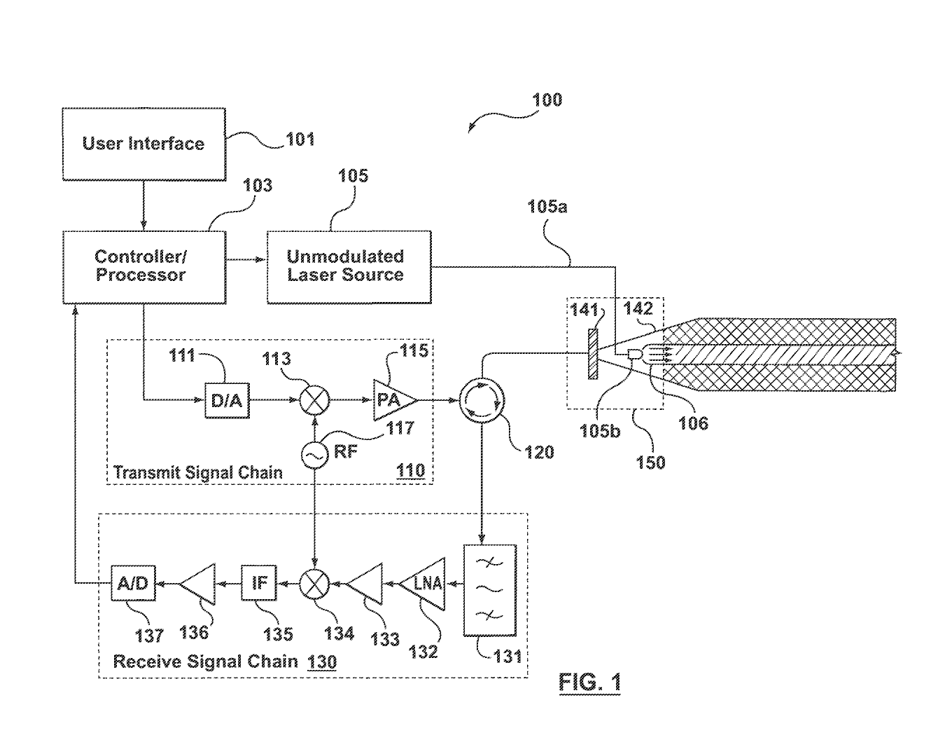

FIG. 1 is a schematic view of a Radio Frequency Identification (RFID) tag reader 100 provided in accordance with aspects of the invention. Those skilled in the art will appreciate that the RFID tag reader may be supported by a suitable combination of hardware, software and firmware, in addition to mechanical structures and packaging. But only those elements required to describe specific aspects of the invention have been illustrated in FIG. 1. Specifically, the RFID tag reader 100 includes a transmit signal chain 110 and a receive signal chain 130. Both the transmit signal chain 110 and the receive signal chain 130 are coupled through a circulator 120 to an antenna 141. The circulator 120 is provided to selectively couple the transmit signal chain 110 and the receive signal chain 130 to the antenna 141. Those skilled in the art will appreciate that the circulator 120 may be replaced by a multiplexer (MUX) or switching circuit in order to achieve substantially the same result.

The antenna 141 is a pencil beam antenna designed to provide a highly focused and thinly shaped lobe 142 (i.e. antenna beam pattern). The RFID tag reader 100 includes a controller 103 also connected to each of the transmit signal chain 110 and the receive signal chain 130. A user interface 101 is further connected to the controller 103.

In the specific example embodiment illustrated in FIG. 1, the RFID tag reader 100 includes an unmodulated laser light source 105 for providing a laser light utilized to aim the highly focused and thinly shaped lobe 142. The unmodulated laser light source 105 is coupled to an optical fiber 105a that is terminated with a lens end-cap 105b, which is arranged in front of the antenna 141 so that the laser light 106 emitted through the lens end-cap 105b is directed through the center of the highly focused and thinly shaped lobe 142 along the length thereof. Those skilled in the art will appreciate that the combination of the unmodulated laser light source 105, optical fiber 105a and the lens end-cap 105b suitably arranged form a means for aiming the highly focused and thinly shaped lobe 142 created by the antenna 141. The antenna 141 and the lens end-cap 105b may be provided in an integrated package 150 to maintain accurate alignment of the laser light 106 and the antenna lobe 142. Again, those skilled in the art will appreciate that the laser light 106 is visible, while the highly focused and thinly shaped lobe 142 created by the antenna 141 is not visible to the human eye, and that the laser light 106 serves to aim the antenna lobe 142. Additionally and/or alternatively, the unmodulated laser light source 105 may be replaced with another means of aiming the highly focused and thinly shaped lobe 142, as described above.

With continued reference to FIG. 1, the transmit signal chain 110 includes a RF/microwave oscillator 117. An output of the oscillator 117 is coupled to a mixer/modulator 113. The mixer/modulator 113 is also coupled to receive an analog input from a digital-to-analog converter 111, which is itself coupled to receive a digital signal from a controller 103. The output of the mixer/modulator 113 is coupled into a pre-transmission power amplifier 115 before being sent to the circulator 120.

In operation, the transmit signal chain 110 converts a digital communication signal from the controller 103 into an analog communication signal at a RF frequency that can be transmitted by the antenna 141. In some very specific embodiments, the band of RF frequencies chosen for operation is in one of the ISM (industrial, Scientific and Medical) bands defined by the International Telecommunications Union (ITU). Additionally and/or alternatively, any RF band can be used that does not interfere with RF frequencies used for other types of wireless communication.

The receive signal chain 130 is coupled to receive an input from the antenna 141 via the circulator 120, and an input from the oscillator 117 of the transmit signal chain 110. The input from the circulator 110 is passed through a band pass filter 131. The output of the band pass filter 131 is in turn coupled in series to a low noise amplifier (LNA) 132 and receive-side pre-amplifier 133. The output of the receive-side pre-amplifier 133 is coupled to a down-converter 134, which may be embodied as a mixer similar to the mixer 113. In series, after the down-converter 134, the receive signal chain 130 includes an IF (intermediate frequency) filter 135, a post-amplifier 136, which is then coupled to the Analog-to-Digital Converter (A/D) 137 The output of the A/D 137 is coupled into the receiving digital signal processor (not shown) within the controller 103. In operation, the receive signal chain 130 receives and delivers down-converted communication signals received by the antenna 141.

Additionally and/or alternatively, the output of the receive-side pre-amplifier 133 can be split into I and Q (i.e. in-phase and quadrature branches respectively) branches. The I and Q branches can be substantially identical to the remainder of the receive signal chain 11 0 described above. I-Q detection permits the subtraction of clutter from the raw return more effectively than other methods such as envelope detection. However, I-Q detection requires more complex hardware.

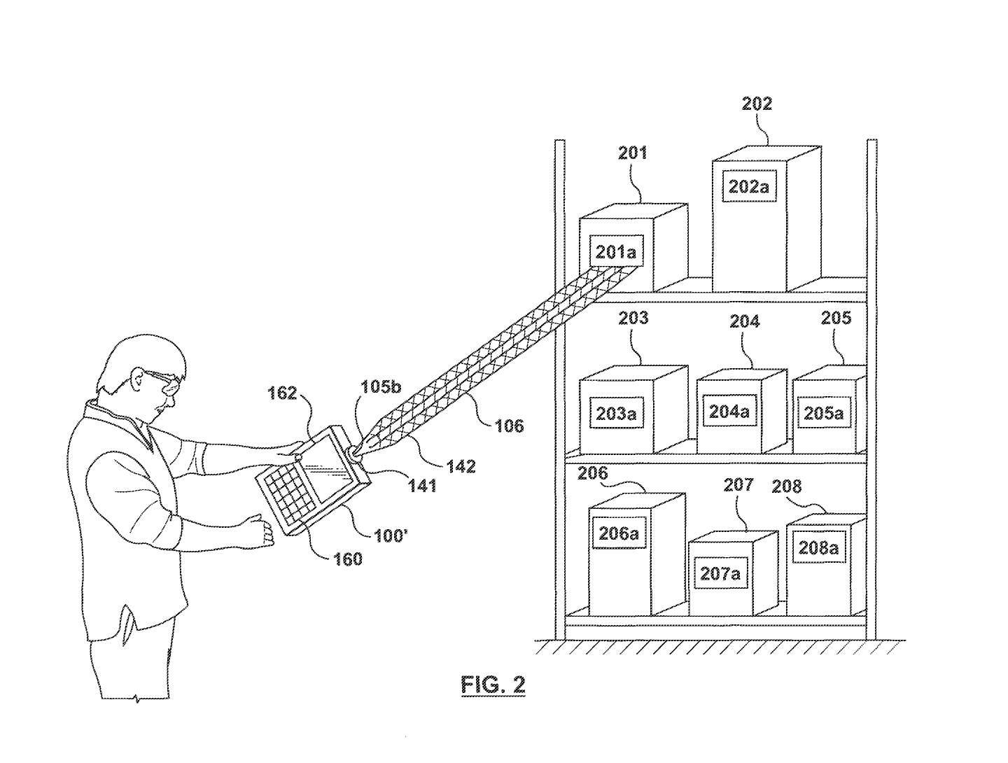

Turning to FIG. 2, provided is an illustration depicting a method of use of a RFID tag reader 100′ in accordance with aspects of the invention. For the sake of this example only, the RFID tag reader 100 illustrated in FIG. 2 contains all of the components shown in the RFID tag reader 100 shown in FIG. 1. The illustration in FIG. 2 depicts a very specific scenario to help explain aspects of the invention and is not meant to limit applications of RFID tag readers created in accordance with aspects of the invention. The illustration in FIG. 2 includes a user 50 using the RFID tag reader 100′, that has been provided in accordance with aspects of the invention. That is, with further reference to FIG. 1, the RFID tag reader 100′ includes the pencil beam antenna 141 and lens end-cap 105b, which is internally connected to the laser source 105 (not shown in FIG. 2). The RFID tag reader 100′ additionally includes a user interface provided in the form of a keypad 160 and a display 162. The user interface depicted is provided as an example only, and in other embodiments, the user interface may include a similar or different combination of features. Again, in operation, the RFID tag reader 100′ emits a highly focused and thinly shaped lobe 142 (as previously shown in FIG. 1), which is created by the pencil beam antenna 141, and a laser light 106, which is emitted from the lens end-cap 105b and is aligned with the lobe 142.

The illustration in FIG. 2 also includes a number of boxes 201, 202, 203, 204, 205, 206, 207, 208, each having a respective RFID tag 201a, 202a, 203a, 204a, 205a, 206a, 207a and 208a affixed thereon. In operation, a conventional RFID tag reader would not be able to selectively communicate with any of the RFID tags 201a, 202a, 203a, 204a, 205a, 206a, 207a and 208a, and would instead be forced to communicate with all of them. In contrast, the RFID tag reader 100′, having the pencil beam antenna 141, can be used to selectively communicate with any of the RFID tags 201a, 202a, 203a, 204a, 205a, 206a, 207a and 208a to the exclusion of the others. In FIG. 2, the user 50 is shown selecting box 201 with corresponding RFID tag 201a using the RFID tag reader 100′. This is accomplished by aligning the laser light 106 over at least a portion of the RFID tag 201a, thereby also aligning the highly focused and thinly shaped lobe 142 with the antenna lobe created by the antenna (not shown) within the RFID tag 201a. Likewise, any of the other RFID tags 202a, 203a, 204a, 205a, 206a, 207a and 208a may be selected in the same way.

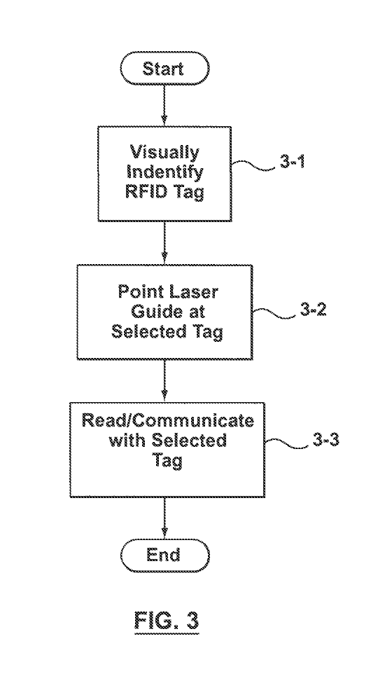

FIG. 3 is a first flow chart illustrating general method steps for operating a RFID tag reader in accordance with aspects of the invention. Starting at step 3-1, the method includes visually identifying a RFID tag to read/program with the RFID tag reader configured in accordance with aspects of the invention. At step 3-2 the method includes pointing a laser guide at the selected RFID tag, thereby aligning a highly focused and thinly shaped lobe created by a pencil beam antenna (the antenna) utilized by the RFID tag reader directly over the RFID tag and within the lobe of the antenna in the RFID tag. Since RFID tags have comparably low available transmission power the lobe of the antenna in the RFID tag will be relatively small. As a result, communication between the RFID tag reader and selected RFID tag will occur by way of the overlap of the highly focused and thinly shaped lobe created by the pencil beam antenna utilized by the RFID tag reader and the relatively small lobe created by the antenna in the selected RFID tag. Other RFID tags proximate to the selected RFID tag will not be able to establish a communication link with the RFID tag reader because the lobes created by their respective antennas will not effectively overlap with the highly focused and thinly shaped lobe created by the antenna included in the RFID tag reader. However, there may be an exception to this if the RFID tag selected is very close to another RFID tag, and in which case it may have not been possible to visually distinguish a separation between the two tags in the first place. Finally, at step 3-3, the method includes communication between the RFID tag reader and the selected RFID tag, with the exclusion of other RFID tags in the area.

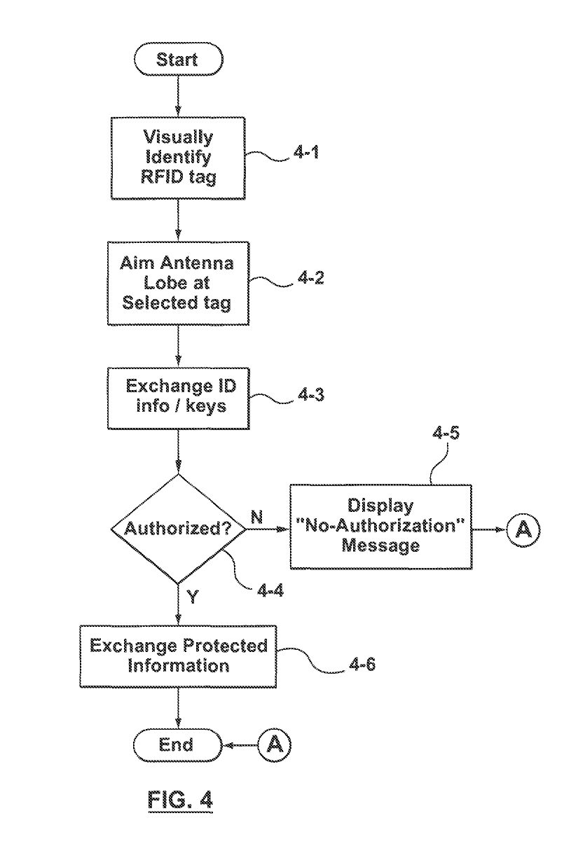

FIG. 4 is a second flow chart illustrating method steps for operating a RFID tag reader in accordance with aspects of the invention. Starting at step 4-1, the method includes visually identifying a RFID tag to read/program with the RFID tag reader configured in accordance with aspects of the invention. At step 4-2, the method includes aiming the highly focused and thinly shaped lobe created by the pencil beam antenna, thereby aligning the highly focused and thinly shaped lobe directly over the RFID tag and within the lobe of the antenna in the RFID tag. As noted above, aiming the highly focused and thinly shaped antenna lobe may include the use of a laser light aligned with the lobe. Additionally and/or alternatively, a viewfinder or another mechanical means of aligning the antenna lobe may be utilized.

At step 4-3, the method includes the exchange of identification keys between the RFID tag reader and the selected RFID tag. The use of identification keys, such as for example, encryption keys, may serve to provide a level of security to the communication between the RFID tag reader and the selected RFID tag. In such embodiments, the RFID tag reader, in addition to other stored information, would have to store a local identification key and have a processor programmed to manage the exchange of identification keys with a RFID tag.

Once the identification keys are exchanged, at step 4-3, the method includes determining whether or not communication between the RFID tag reader and the selected RFID tag is authorized. If communication is not authorized (no path, step 4-4), at step 4-5 the method includes displaying a “no authorization” message to the user of the RFID tag reader or otherwise providing a failure to authenticate message to a user or system utilizing the RFID tag reader. If communication is authorized (yes path, step 4-4), at step 4-6 the method includes enabling communication between the RFID tag reader and the RFID tag in which protected information between the two is exchanged.

While the above description provides example embodiments, it will be appreciated that the present invention is susceptible to modification and change without departing from the fair meaning and scope of the accompanying claims. Accordingly, what has been described is merely illustrative of the application of aspects of embodiments of the invention and numerous modifications and variations of the present invention are possible in light of the above disclosure.

1. A Radio Frequency Identification (RFID) tag reader comprising:
a highly-directional antenna operable to create a highly focused and thinly shaped lobe, the lobe being the volume of space within which Radio Frequency (RF) signals can be detected and coupled to the RFID tag reader and also within which RF signals can propagate after being transmitted by the RFID tag reader;
a transmit signal chain operable to produce a transmission signal at a RF frequency, the transmit signal chain operably connectable to the highly-directional antenna;
a receive signal chain operable to accept and down-convert a received signal at a RF frequency, the receive signal chain operably connectable to the highly-directional antenna for accepting the received signal at the RF frequency; and
a controller for managing the operation of the RFID tag reader, the controller operably connected to the transmit and the receive signal chains.

2. A RFID tag reader according to claim 1, further comprising a user interface for permitting a user to direct the use of the RFID tag reader, the user interface operably connectable to the controller, wherein the controller accepts input instructions from a user through the user interface and provides feedback to the user through the user interface.

3. A RFID tag reader according to claim 2, wherein the user interface includes at least one of a keypad, a display and a touch screen.

4. A RFID tag reader according to claim 1, wherein the controller is further connectable to another system employing the functionality of the RFID tag reader.

5. A RFID tag reader according to claim 1, further comprising a circulator for selectively connecting at least one of the transmit signal chain and the receive signal chain to the highly directional antenna.

6. A RFID tag reader according to claim 1, further comprising a multiplexer for selectively connecting at least one of the transmit signal chain and the receive signal chain to the highly directional antenna.

7. A RFID tag reader according to claim 1, further comprising a targeting element for aiming the highly focused and thinly shaped lobe created by the highly-directional antenna.

8. A RFID tag read according to claim 7, wherein the targeting element comprises a coherent light source that emits laser light substantially through the center of the highly focused and thinly shaped lobe created by the highly-directional antenna, wherein the laser light is within the spectrum of visible light and in operation serves as a guide for directing the highly focused and thinly shaped lobe of the antenna.

9. A RFID tag reader according to claim 8, further comprising an optical light emitter connected to the coherent light source, the optical light emitter arranged in front of the highly-directional antenna, whereby in operation, the laser light and the antenna lobe overlap along the length of the antenna lobe.

10. A RFID tag reader according to claim 7, wherein the targeting element comprises a viewfinder for aiming the highly focused and thinly shaped lobe.

11. A method of operating a Radio Frequency Identification (RFID) tag reader having a highly-directional antenna, the highly-directional antenna operable to produce a highly-focused and thinly shaped lobe, the method comprising:
aiming the highly-focused and thinly shaped lobe at a RFID tag;
transmitting a signal to the RFID tag; and
receiving a signal back from the RFID tag.

12. A method according to claim 11, further comprising visually selecting the RFID tag with which communication is desired.

13. A method according to claim 11, further comprising using a targeting element for aiming the highly focused and thinly shaped lobe at the RFID tag.

14. A method according to claim 13, wherein the targeting element includes one of a laser sight aligned with the highly focused and thinly shaped lobe and a viewfinder.

15. A method according to claim 11, further comprising:
receiving a response including an authentication key from the RFID tag;
determining whether or not communication is permitted between the RFID tag reader and the RFID tag based on evaluation of the authentication key;
indicating to the user the result of the evaluation; and
permitting communication depending on the result of the evaluation.

16. A method according to claim 11, further comprising:
receiving a response including an authorization message from the RFID tag;
determining whether or not communication is permitted between the RFID tag reader and the RFID tag based on evaluation of the authorization message;
indicating to the user the result of the evaluation; and
permitting communication depending on the result of the evaluation.

17. A method according to claim 11, further comprising:
transmitting an authentication key to the RFID tag;
receiving a response including an authorization message from the RFID tag;
determining whether or not communication is permitted between the RFID tag reader and the RFID tag based on evaluation of the authorization message;
indicating to the user the result of the evaluation; and
permitting communication depending on the result of the evaluation.
